(19) United States
(12) Patent Application Publication
(10) Pub. No.: US 2006/0077281 A1
(43) Pub. Date: Apr. 13, 2006

(54) Image pickup device and portable terminal

(75) Inventor: Hiroshi Hasegawa, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/288,825

(22) Filed: Nov. 28, 2005

(30) Foreign Application Priority Data
Feb. 12, 2004 (JP) JP2004-349534

(51) Int. Cl. H04N 5/225

(52) U.S. Cl. 348/360

(57) ABSTRACT

To obtain a small-sized and thin image pickup device suitable to be housed in a portable terminal, having excellent shielding properties by which communication functions are not obstructed by electromagnetic waves generated by an image sensor and the image sensor is not affected by electromagnetic waves generated for the purpose of communication, without enlarging the image pickup device. To make the image pickup device to be one wherein there are provided a photographing optical system for guiding light of a subject, a lens barrel for holding the photographing optical system, an image sensor that receives light of a subject guided by the photographing optical system, and converts it into an image signal and a circuit board on which the image sensor is attached, and at least a part of the lens barrel is formed to have electrical conductivity.

This application is based on Japanese Patent Application No. 2004-349534 filed on Dec. 2, 2004, in Japanese Patent Office, the entire content of which is hereby incorporated by reference.

### FIELD

The present invention relates to an image pickup device and a portable terminal.

### BACKGROUND

A small-sized and thin image pickup device has so far been loaded in a portable terminal representing a small-sized and thin electronic equipment such as a cell-phone and PDA (Personal Digital Assistant), thereby, it has become possible to transmit mutually not only voice information but also image information to a remote place.

In these image pickup devices, there are used image sensors including a CCD (Charge Coupled Device) type image sensor and a CMOS (Complementary Metal-Oxide Semiconductor) type image sensor.

As a structure of a casing for a video camera wherein electromagnetic wave interference between a camera portion and an external equipment carrying a camera is prevented, for these image pickup devices each employing a solid-state image sensor, there is disclosed a structure wherein a camera portion equipped with an image sensor and a circuit portion are sealed hermetically by a conductive plate and a conductive case, and a conductive glass is fit on an entrance window for light of a subject (for example, see Patent Document 1).

(Patent Document 1) TOKKAIHEI No. 11-239288

With the portable terminal carrying an image pickup device, it is possible to transmit an image picked up by using communication functions while taking an image with the image pickup device, and in this case, the communication functions should not be obstructed by the electromagnetic wave generated by the image sensor, the image sensor should not be affected by the electromagnetic wave generated for the purpose of communication, and defects should not be caused on the image picked up.

In the structure of the casing described in the Patent Document 1, a camera portion and a circuit portion related to the camera portion are shielded independently by a conductive plate, a conductive case and conductive glass in a way to be packed, outside the camera portion and the circuit portion related to the camera portion, a space is present between a lens barrel and a conductive case, and an external form grows greater, resulting in the structure which is unsuitable to be housed in a small-sized and thin portable terminal.

Further, when an image pickup device is housed in a small equipment such as a portable terminal, the image pickup device is required to be made as small as possible, so that an electromagnetic wave may not be blocked by the image pickup device itself.

### SUMMARY

In view of the problems stated above, an object of the invention is to obtain a small and thin image pickup device suitable to be loaded in the portable terminal wherein a size of the image pickup device is not increased, communication functions are not obstructed by the electromagnetic wave generated by the image sensor and excellent shielding properties by which the image sensor is not affected by electromagnetic waves generated for the purpose of communication are provided.

The object mentioned above can be achieved by the following means.

Item 1

An image pickup device having therein a photographing optical system guiding light of a subject, a lens barrel supporting the photographing optical system, an image sensor that receives the light of a subject guided by the photographing optical system, and converts it into an image signal and a circuit board on which the image sensor is fixed, wherein at least a part of the lens barrel is formed to have electric conductivity.

The means mentioned above makes it possible to obtain a small and thin image pickup device having excellent shielding properties by which an electromagnetic wave generated from the image sensor and an electromagnetic wave generated for the purpose of communication do not affect each other, without increasing a size of the image pickup device, because it is not necessary to provide a shielding member having a space between the lens barrel and the shielding member.

### BRIEF DESCRIPTION OF THE DRAWINGS

FIG. 1 is a perspective view showing an example of an image pickup device relating to the First Embodiment.

FIG. 2 is a cross-sectional view showing an example of an image pickup device relating to the First Embodiment.

FIG. 3 is a cross-sectional view showing another example of an image pickup device relating to the First Embodiment.

FIG. 4 is a cross-sectional view showing still other example of an image pickup device relating to the First Embodiment.

FIG. 5 is a cross-sectional view showing still other example of an image pickup device relating to the First Embodiment.

FIG. 6 is a cross-sectional view showing an example of an image pickup device relating to the Second Embodiment.

FIG. 7 is a cross-sectional view showing another example of an image pickup device relating to the Second Embodiment.

FIG. 8 is a diagram wherein a transparent membrane is not used but another method is used on an optical surface on which a transparent membrane is desired to be formed.

FIG. 9 is an appearance diagram of cell-phone T that is an example of a portable terminal equipped with an image pickup device relating to the aforesaid embodiment.

### DESCRIPTION OF THE PREFERRED EMBODIMENT

In the embodiment of the invention, the object of the invention can also be achieved by taking the following means in place of the means mentioned above. Incidentally, with respect to the following means, either all of the means or a part of the means may be practiced to achieve the object of the invention.

Item 2

The image pickup device according to Item 1, wherein a portion having electrical conductivity on the lens barrel is grounded on a ground wiring of the circuit board.

Item 3

The image pickup device according to Item 1 or Item 2, wherein the lens barrel has been given a surface treatment having electrical conductivity.

Item 4

The image pickup device according to Item 1 or Item 2, wherein the lens barrel is made of conductive resin.

Item 5

The image pickup device according to any one of Item 1-Item 4, wherein a conductive membrane is formed on any one surface of the photographing optical system, and a portion where the conductive membrane is formed is connected to a portion having electrical conductivity on the lens barrel.

Item 6

The image pickup device according to Item 5, wherein a surface on which the conductive membrane is formed is the last surface of the photographing optical system.

Item 7

An image pickup device having a photographing optical system that guides light of a subject, a lens barrel that holds the photographing optical system, an image sensor that receives light of a subject guided by the photographing optical system and converts it into an image signal, and a circuit board on which the image sensor is fixed wherein a conductive member having a shape following a part of inner surface of the lens barrel or following a part of an outer surface of the lens barrel is provided.

Item 8

The image pickup device according to Item 7, wherein the conductive member is grounded on a ground wiring of the circuit board.

Item 9

The image pickup device according to Item 7 or Item 8, wherein a conductive membrane is formed on the surface closest to a subject on the photographing optical system, and a portion where the conductive membrane is formed is connected to the conductive member.

Item 10

The image pickup device according to Item 7 or Item 8, wherein a conductive membrane is formed on the surface closest to an image plane on the photographing optical system and a portion where the conductive membrane is formed is connected to the conductive member.

Item 11

A portable terminal having the image pickup device according to any one of Item 1-Item 10.

The Items 1-10 above make it possible to obtain a small and thin image pickup device having excellent shielding properties wherein electromagnetic waves generated from the image pickup device and electromagnetic waves generated for the purpose of communication do not affect each other while a form of the image pickup device remains unchanged.

The Item 5 or the Item 6 above makes it possible to obtain a small and thin image pickup device having more excellent shielding properties.

The Item 7 or the Item 8 above makes it possible to obtain a small and thin image pickup device having excellent shielding properties wherein electromagnetic waves generated from the image pickup device and electromagnetic waves generated for the purpose of communication do not affect each other, while a form of the image pickup device remains unchanged.

The Item 9 or the Item 10 above makes it possible to obtain a small and thin image pickup device having more excellent shielding properties.

The Item 11 above makes it possible to obtain an excellent portable terminal, wherein electromagnetic waves generated from the image pickup device and electromagnetic waves generated for the purpose of communication do not affect each other.

The invention will be explained in detail as follows, referring to the embodiment to which, however, the invention is not limited.

### First Embodiment

As the First Embodiment, there will be explained as follows, an image pickup device wherein at least a part of a lens barrel that holds a picture-taking lens is formed so that it may have electrical conductivity.

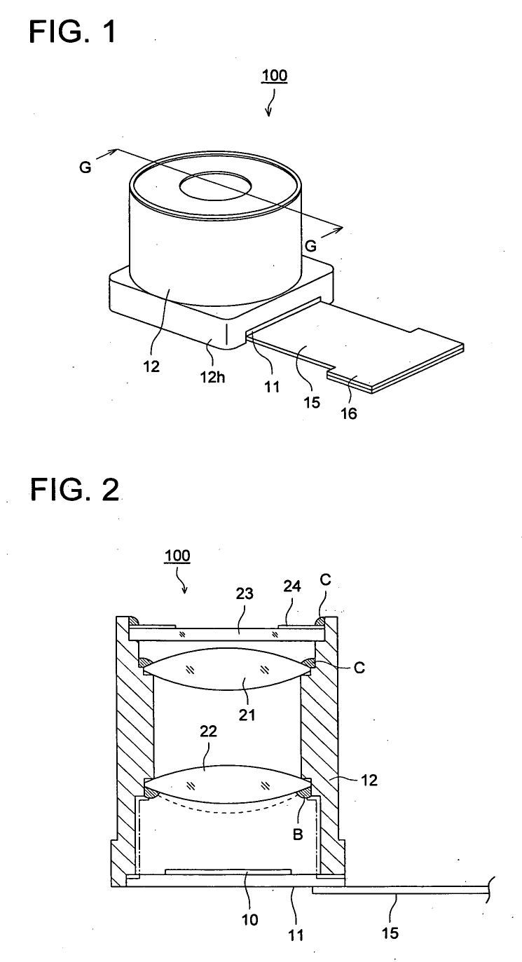

FIG. 1 is a perspective view showing an example of image pickup device 100 relating to the First Embodiment.

Image pickup device 100 shown in FIG. 1 is composed of printed board 11 equipped with an image sensor and of lens barrel 12 that holds an image pickup optical system. On this lens barrel 12, there is formed solidly wall surface 12h that surrounds partially a peripheral portion of the printed board 11. Flexible printed board 15 is connected to the printed board 11, and connecting portion 16 on the end portion is constructed so that it may be connected to another control circuit board of the portable terminal.

On the printed board 11 and on the flexible printed board 15, there are provided electric parts such as various resistors and capacitors.

FIG. 2 is a cross-sectional view showing an example of the image pickup device relating to the First Embodiment. FIG. 2 shows schematically a section taken on line G-G of image pickup device 100 shown in FIG. 1. Incidentally, in the first drawings, the same symbols are given to the same functional members for explanation to avoid overlapping of the explanation.

In FIG. 2, the numeral 10 represents an image sensor for which a CCD type image sensor and a CMOS type image sensor are used. The numeral 11 represents a printed board on which the image sensor 10 is fixed, and flexible printed board 15 is connected to the printed board 11.

The numeral 21 represents a first lens, 22 represents a second lens and 23 represents an infrared blocking filter, which constitute an image pickup optical system. A fixed diaphragm is represented by 24, and a lens barrel made of a light shielding, non-conductive and resin material is represented by 12, and this lens barrel 12 holds the first lens 21, the second lens 22, the infrared blocking filter 23 and the fixed diaphragm 24, and is fixed on the printed board 11.

Each of the surface shown with one-dot chain lines on an inner wall of the lens barrel and the surface that comes in contact with the printed board 11 is given the surface treatment so that the surface may have electrical conductivity. This surface treatment is one, for example, wherein copper is evaporated and nickel is further evaporated thereon. Meanwhile, it is preferable that a wall surface portion where surface treatment is conducted is coated black.

On the surface shown with broken lines facing the image sensor 10 on the second lens 22 that is positioned at the rearmost portion of the image pickup optical system, namely, on the rearmost surface, there is formed a transparent conductive membrane. As this conductive membrane, known ITO membrane (indium tin oxide) having the low resistance is preferable. As a method of making the ITO membrane, it is possible to apply methods of sputtering, vacuum evaporation, sol-gel process and cluster beam evaporation and a PLD method, which are publicly known. Owing to this, the surface facing the image sensor 10 on the second lens 22 may be made to have electrical conductivity while having transmittance of 80% or more.

The surface that has electrical conductivity and faces the image sensor 10 on the second lens 22 is glued, with conductive adhesives B, to lens barrel 12 which has been subjected to surface treatment to have electrical conductivity, as illustrated, to have continuity. Further, a ground pattern is formed on the surface coming into contact with lens barrel 12 on the printed board 11, whereby, the portion of the surface treatment on the lens barrel 12 is grounded on the ground pattern. Due to this, it is possible to create a state wherein a space closer to an image sensing surface on the image sensor 10 is shielded.

It is also possible to construct so that continuity is obtained when the second lens 22 is incorporated on the receiving surface, by forming a transparent conductive membrane on the surface of the second lens 22 facing a subject and by forming, also on the receiving surface of the second lens 22, the conductive surface treatment to be given to lens barrel 12. In this case, the adhesives do not need to have electrical conductivity.

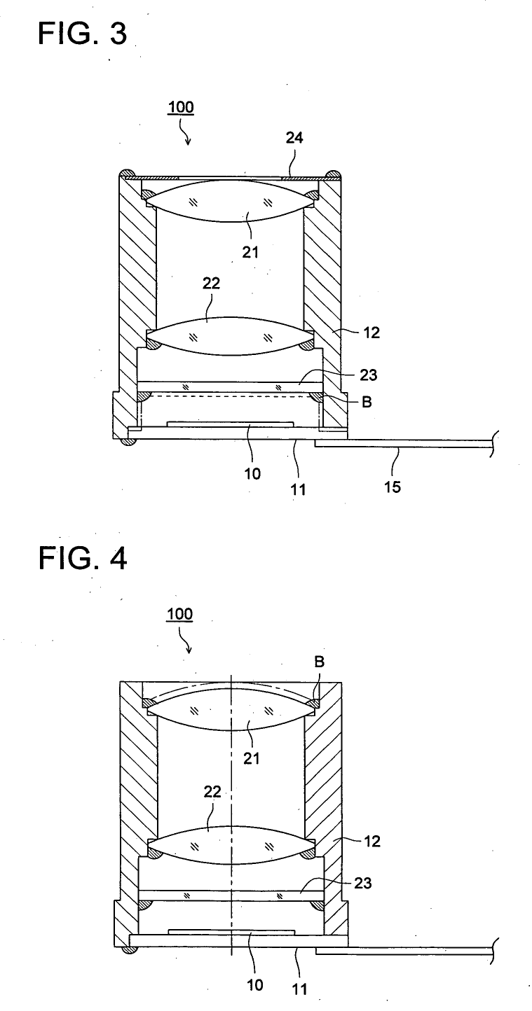

FIG. 3 is a cross-sectional view showing another example of image pickup device 100 relating to the First Embodiment. In the same way, FIG. 3 also shows schematically a section taken on line G-G of image pickup device 100 shown in FIG. 1.

In FIG. 3, an infrared blocking filter is arranged at the rearmost portion of the image pickup optical system, then, a transparent conductive membrane is formed on a surface facing image sensor 10 on the infrared blocking filter 23, namely on the rearmost surface shown with broken lines, and conductive surface treatment is given to the surface shown with one-dot chain lines on an inner wall of the lens barrel 12 and to the surface that comes in contact with printed board 11. In this way, it is also possible to create a state wherein a space closer to an image plane on the image sensor 10 is shielded. In this case, a thickness of the image pickup device 100 can be reduced by an amount equivalent to a thickness of the infrared blocking filter, compared with one shown in FIG. 1.

It is also possible to construct so that continuity is obtained when the infrared blocking filter 23 is incorporated on the receiving surface, by forming a transparent conductive membrane on the surface facing a subject on the infrared blocking filter 23 and by forming, also on the receiving surface of the infrared blocking filter 23, the conductive surface treatment to be given to lens barrel 12.

Incidentally, although an example wherein conductive surface treatment is given to a part of an inner wall of lens barrel 12 closer to an image sensor, has been explained, the surface treatment can also be given to the entire surface of the inner wall, or the surface treatment of the lens barrel 12 only is enough if it offers desired effects.

As explained above in FIG. 2 and FIG. 3, it is possible to obtain an image pickup device having excellent shielding properties, by giving surface treatment to a lens barrel so that it may have electrical conductivity.

Though an example wherein a transparent conductive membrane is formed on the rearmost surface of the image pickup optical system has been explained, it is also possible to construct, without being limited to the foregoing, so that a transparent conductive membrane formed on any one surface of the image pickup optical system may come in contact mutually with a conductive portion resulted from surface treatment formed on lens barrel 12.

Further, the conductive surface treatment formed on an inner wall of the lens barrel 12 may also be formed with a transparent conductive membrane in the same way as in the optical system. Even in this case, it is preferable that black coating is provided on the transparent conductive membrane as antireflection coating.

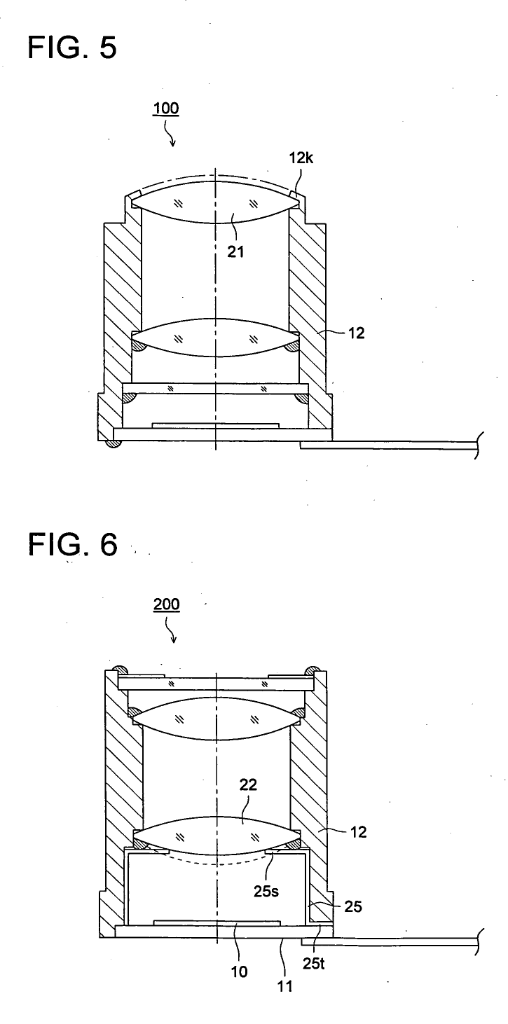

Next, an image pickup device wherein a lens barrel is made of conductive resin will be explained as follows, referring to FIG. 4 and FIG. 5.

FIG. 4 is a cross-sectional view showing another example of image pickup device 100 relating to the First Embodiment. In the same way, FIG. 4 also shows schematically a section.

Lens barrel 12 of image pickup device 100 shown in FIG. 4 is one formed through a method of molding by using a conductive resin material. For example, those wherein conductive fibers are added to known polycarbonate resin can be used as the conductive resin material. Metal fibers and nonmetallic fibers such as carbon fibers, for example, can be used as the conductive fiber. From the viewpoint of clogging in the gate portion and adhesion to screws, it is preferable to use nonmetallic fibers.

On the surface shown with one-dot chain lines on the first lens 21, there is formed a transparent conductive membrane. The lens barrel 12 made of conductive resin and the surface of the first lens on which the transparent conductive membrane is formed are glued together by conductive adhesive B as illustrated so that electric continuity may be obtained when the first lens 21 is fixed. Further, a ground pattern is formed and grounded on the surface of the printed board 11 that comes in contact with the lens barrel 12. Owing to this, the image pickup device 100 can be shielded totally.

Meanwhile, it is also possible to construct so that continuity is obtained when the first lens 21 is incorporated on the receiving surface, by forming a transparent conductive membrane on the surface facing an image plane on the first lens 22. In this case, the adhesive does not need to have electrical conductivity.

FIG. 5 is a cross-sectional view showing still another example of image pickup device 100 relating to the First Embodiment. In the same way, FIG. 5 also shows schematically a section.

FIG. 5 is an example wherein fixing of the first lens 21 and electric continuity with lens barrel 12 are conducted by calking the first lens 21 at tip portion 12k of the lens barrel 12, as the structure shown in FIG. 4.

As explained above in FIG. 4 and FIG. 5, it is possible to obtain an image pickup device having excellent shielding properties, by forming a lens barrel with conductive resin so that the lens barrel may have electrical conductivity. Further, if the desired effects are obtained only by electrical conductivity of the lens barrel, the electrical conductivity alone is enough.

Though an example wherein a transparent conductive membrane is formed on the first lens 21 has been explained, it is also possible to construct, without being limited to the foregoing, so that a transparent conductive membrane formed on any one surface of the image pickup optical system may come in contact mutually with the lens barrel 12.

Namely, by forming a lens barrel so that at least a part thereof may have electrical conductivity by giving conductive surface treatment to the lens barrel or by making the lens barrel with conductive resin, as explained in the First Embodiment, it is possible to obtain a small and thin image pickup device having excellent shielding properties wherein electromagnetic waves generated from an image sensor and electromagnetic waves generated for the purpose of communication do not affect each other, without changing the form of the image pickup device. Further, it is not necessary to add parts newly for shielding, because functional members provided originally on the image pickup device are used, which results in effects not only of miniaturization but also of cost reduction.

### Second Embodiment

An image pickup device wherein a conductive member is provided on a part of an inner surface of a lens barrel or a conductive member is provided along an outer surface of a lens barrel will be explained as follows as the Second Embodiment.

FIG. 6 is a cross-sectional view showing an example of image pickup device 200 relating to the Second Embodiment. FIG. 6 shows schematically a section of the image pickup device wherein a conductive member is provided along a part of an inner surface of a lens barrel.

In FIG. 6, lens barrel 12 is made of a light shielding and non-conductive resin material, and conductive member 25 that is made of metal and has electrical conductivity, for example, is attached on an inner surface of the lens barrel 12 facing image sensor 10. Bent portion 25t representing a part of the conductive member 25 is formed to come in contact with printed board 11, and on this position of the printed board 11, there is formed a ground pattern so that the conductive member 25 may be grounded by the bent portion 25t. Further, on the conductive member 25, there is formed an opening section which serves also as a fixed diaphragm.

On the other hand, a transparent conductive membrane is formed on a surface (shown with broken lines) of the second lens 22 closer to image sensor 10 which is the surface closest to an image plane on a photographing optical system. Tip 25s of an opening section of the conductive member 25 is in contact with the surface of the second lens 22 on which a transparent conductive membrane is formed. Due to this, it is possible to create a state wherein a space of image sensor 10 closer to the imaging surface side is shielded. Incidentally, if the desired effects are obtained only by the conductive member 25, the conductive member 25 alone is enough.

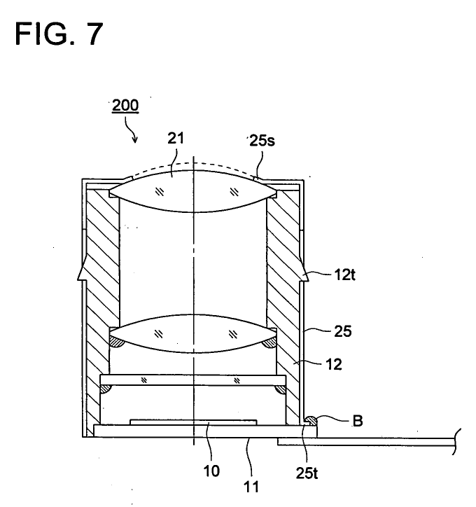

FIG. 7 is a cross-sectional view showing another example of image pickup device 200 relating to the Second Embodiment. FIG. 7 shows schematically a section of the image pickup device wherein a conductive member is provided along an outer surface of a lens barrel.

In FIG. 7, lens barrel 12 is made of a light shielding and non-conductive resin material, and conductive member 25 that is made of metal and has electrical conductivity, for example, is attached on an outer surface of the lens barrel 12. This conductive member 25 is engaged with projection 12t formed on the side of the lens barrel 12 to be incorporated. This conductive member 25 presses and fixes the first lens 21 with opening 25s that serves also as a fixed diaphragm. Bent portion 25t representing a part of the conductive member 25 is formed to be close to printed board 11, and at this position on the printed board 11, a ground pattern is formed so that the conductive member 25 may be grounded by adhering the bent portion 25t with adhesives B.

On the other hand, a transparent conductive membrane is formed on a surface (shown with broken lines) of the first lens 21 closer to subject side which is the surface closest to a subject on a photographing optical system. Tip 25s of an opening section of the conductive member 25 presses the surface of the first lens 21 on which a transparent membrane is formed, and due to this, it is possible to create a state wherein a space in the image pickup device 200 is shielded. Incidentally, if the desired effects are obtained only by the conductive member 25, the conductive member 25 alone is enough.

Meanwhile, although there have been explained an example where a transparent conductive membrane is formed on the second lens 22 in FIG. 6 and an example where a transparent conductive membrane is formed on the first lens 21 in FIG. 7, it is naturally possible to arrange an infrared blocking filter on which a transparent conductive membrane is formed at the forefront surface or the rearmost surface of the image pickup optical system, and thereby to construct so that the infrared blocking filter may come in contact with the conductive member.

By providing a conductive member in a form following a part of an inner surface or an outer surface of a lens barrel as explained in the Second Embodiment, it is possible to obtain a small and thin image pickup device having excellent shielding properties wherein electromagnetic waves generated from an image sensor and electromagnetic waves generated for the purpose of communication do not affect each other, without changing the form of the image pickup device.

It is further possible to make shielding properties to be sure, by forming a conductive membrane on the surface closest to the subject side or closest to the image plane side on the photographing optical system, so that the electric continuity between the membrane and a conductive member may be obtained.

Incidentally, though the conductive membrane employing ITO was used as a material of the transparent conductive membrane in the aforesaid explanation, it is naturally possible to use those employing materials such as zinc oxide to which aluminum oxide or gallium oxide is added, or tin oxide in which antimony oxide or fluorine is doped.

Although the one wherein a transparent conductive membrane is formed on any one surface constituting the photographing optical system was explained in each of the First and Second Embodiments, it is also possible to employ the following.

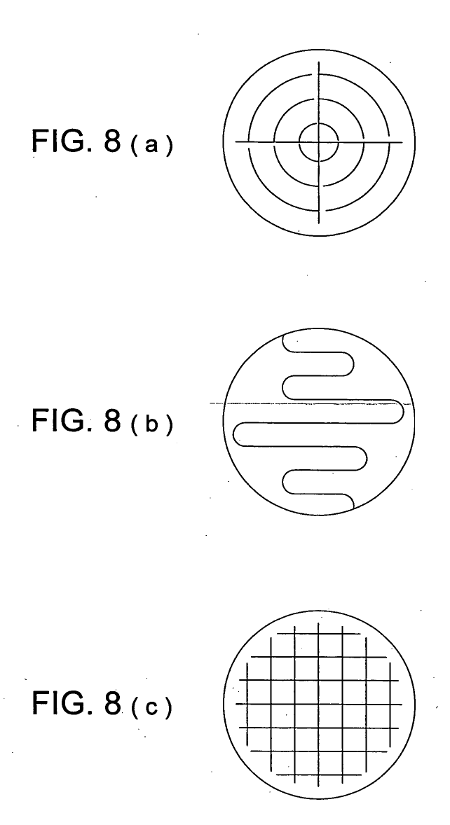

FIG. 8 is a diagram wherein another method in place of a transparent conductive membrane is used on the optical surface on which a transparent conductive membrane needs to be formed. FIG. 8 is one showing schematically an example of a pattern to form a linear pattern that does not transmit light and has electrical conductivity.

A pattern shown with solid lines in FIG. 8 is one formed through vacuum evaporation of plating by the use of conductive materials such as, for example, silver or aluminum. To avoid an influence on image pickup functions, it is preferable that the pattern is formed to be of fine lines and all lines are connected in succession. By doing this, it is possible to ground all lines by touching any one point. To minimize an influence on an image, it is preferable to form the pattern on the optical surface closest to the subject side in the image pickup optical system.

FIG. 8 (a) shows one wherein lines in the radial direction intersect concentric circles, FIG. 8 (b) shows one wherein a pattern is formed by one line to be wavy and FIG. 8 (c) shows one wherein a pattern is formed to be in a checkerboard form. By doing this, it is possible to secure the transmittance higher than that of an ITO membrane.

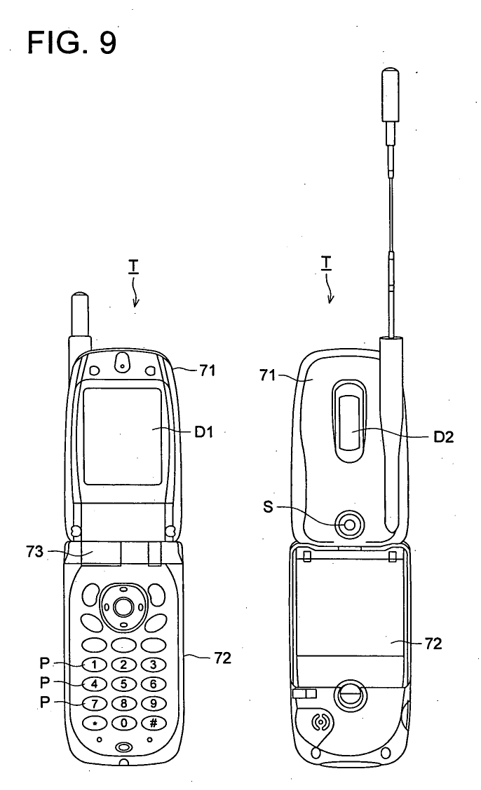

FIG. 9 is an appearance view of cell-phone T representing an example of a portable terminal equipped with an image pickup device relating to the aforesaid embodiment.

In the cell-phone T shown in FIG. 9, upper casing 71 representing a case equipped with display screens D1 and D2 and lower casing 72 equipped with operation button P are connected each other through hinge 73. Image pickup device S is housed in the lower portion of the display screen D2 in the upper casing 71, and the image pickup device S is arranged so that it may take in light through the outer surface side. This image pickup device S corresponds to the image pickup device 100 or image pickup device 200 stated above.

Incidentally, this image pickup device may be arranged at the position at the upper portion or on the side of the display screen D2. The cell-phone is not limited naturally to a folding type.

Due to this, it is possible to obtain an excellent portable terminal wherein electromagnetic waves generated from an image sensor do not obstruct communication functions and an image sensor is not affected by electromagnetic waves generated for the purpose of communication.

What is claimed is:

1. An image pickup device, comprising:
a photographing optical system for guiding light of a subject;
a lens barrel for holding the photographing optical system;
an image sensor for receiving the light of a subject guided by the photographing optical system and converting the light of the subject to an image signal, and
a circuit board which holds the image sensor,
wherein the lens barrel includes a conductive portion which shields an electromagnetic wave.

2. The image pick up device according to claim 1, wherein the circuit board holds the lens barrel.

3. The image pick up device according to claim 1, wherein the circuit board includes a ground wiring, and the conductive portion is electrically connected to the ground wiring, and the conductive portion and the ground wiring shield the image sensor.

4. The image pickup device according to claim 1, wherein the conductive portion includes an electrically conductive surface treatment layer.

5. The image pickup device according to claim 4, wherein the conductive portion includes a vapor deposition layer of copper or nickel.

6. The image pickup device according to claim 1, wherein the conductive portion is a conductive resin portion which composes the lens barrel.

7. The image pickup device according to claim 6, wherein the conductive resin portion includes polycarbonate resin which includes an electrical conductive fiber.

8. The image pickup device according to claim 1, wherein the conductive portion includes a conductive member which has a shape of following a part of an inner surface or an outer surface of the lens barrel.

9. The image pickup device according to claim 8, wherein the conductive member includes metal.

10. The image pickup device according to claim 1, further comprising a conductive layer on any one of surfaces of the photographing optical system,
wherein the conductive layer is electrically connected to the conductive portion, and the conductive layer and the conductive portion shield the image sensor.

11. The image pickup device according to claim 10, wherein the conductive layer includes a transparent conductive layer.

12. The image pickup device according to claim 11, wherein the conductive layer includes Indium Tin Oxide film.

13. The image pickup device according to claim 10, wherein the conductive layer includes a conductive line pattern.

14. The image pickup device according to claim 10, wherein the conductive layer is on an optical surface which is the nearest to the subject.

15. The image pickup device according to claim 10, wherein the conductive layer is on an optical surface which is the nearest to the image sensor.

16. The image pickup device according to claim 10, wherein the conductive layer is on an optical surface of the photographing optical system.

17. The image pickup device according to claim 10, further comprising an infrared blocking filter,
wherein the conductive layer is on a surface of the infrared blocking filter.

18. The image pickup device according to claim 1, wherein the conductive portion surrounds the image sensor.

19. The image pickup device according to claim 1, wherein the conductive portion covers the image sensor.

20. A portable terminal comprising the image pickup device according to claim 1.
